(19) United States
(12) Patent Application Publication
(10) Pub. No.: US 2003/0118259 A1
(43) Pub. Date: Jun. 26, 2003

(54) Plastic bearing apparatus with split spanner bushing

(76) Inventors: Thomas E. Denner, Monson, MA (US); Michael Kidd, Delton, MI (US)

Correspondence Address: William B. Ritchie, Ritchie Law Offices, 43 Jackson Street, Concord, NH, 03301, US

(21) Appl. No.: 10/326,872

(22) Filed: Sep. 26, 2002

Related U.S. Application Data
(63) Continuation-in-part of application No. 09/845,821, filed on Apr. 30, 2001, now abandoned.

(51) Int. Cl. F16C 13/00

(52) U.S. Cl. 384/416

(57) ABSTRACT

A bearing assembly having integral molded bearing surfaces. Each bearing surface is molded within its respective inner and outer race. The use of plastic injection molded parts enables high precision with low cost to achieve a reliably rotating caster wheel. The use of integral molded bearing surfaces within the respective races eliminates the problem of having to remove flash from the molding process or concern about indentations made by ejection pins if a separate bearing part were used. The use of a split spanner bushing with the openings of the inner race members permits the bearings to be more easily assembled as well provides greater strength and integrity to the bearing assembly once it is molded into a hub and wheel.

This application is a continuation-in-part of U.S. patent application Ser. No. 09/845,821, filed Apr. 30, 2001, now abandoned.

### BACKGROUND OF THE INVENTION

1. Field of the Invention

This invention relates to the field of wheels and, in particular, bearings for caster wheels.

2. Description of Related Art

For many years, most high quality wheels for casters such as shopping carts have utilized bearings that include a pair of steel races and steel ball bearings, where each piece is assembled separately into the wheel. Because each part of this bearing assembly is assembled separately, the system relies on the precision of the interlocking structural parts to control the tightness of the bearing. Due to the inherent problems of mass-producing caster wheels with such precision, this method of production results in many caster wheels having less than the required tolerances to ensure a consistent smooth operation. This characteristic can frequently cause the well known “wobble wheel”. Additionally, the cost and inefficiency in manufacturing the assembly is high, and thereby translates to higher consumer pricing.

High strength polymer resin compounds have been used extensively for making wheels. More recently, the use of bearing components that were molded in the hubs of such wheels has been suggested to absorb shock loads and to lower the cost of the wheel and bearing assemblies.

Representative of this method is U.S. Pat. No. 5,871,286 issued Feb. 16, 1999, which discloses a molded wheel having a bearing assembly molded into the wheel hub. The device includes a synthetic resin outer bearing race element embedded in the hub of the molded wheel and having a cylindrical inner sliding, journal type bearing surface. An inner bearing assembly includes two molded synthetic resin bearing halves having continuous cylindrical outer bearing surfaces disposed within the outer bearing race in sliding engagement with the inner bearing surface of the outer race. The bearing halves of the inner bearing assembly abut each other at their inner ends and may include interlocking structural features at their inner ends that enable securing of the bearing halves together at their inner ends while presenting a continuous outer cylindrical bearing sliding surface that cooperates with the adjacent surface of the outer race. A wheel axle extends through the inner bearing assembly and supports the wheel and bearing assembly for rotation relative to a wheel support.

Although the above invention overcomes some disadvantages of wheel bearings, there are still many disadvantages. First, the outer race is the only bearing element molded into the wheel hub. This leaves the bearing susceptible to the “wobble wheel” phenomenon due to uncontrollable looseness. This effect translates to bearing assemblies having inconsistent tolerances. Second, although this invention attempts to control potential looseness using an interlocking structure between the bearing halves, this structure will still suffer natural mechanical wear and tear resulting in the “wobble wheel” effect.

Nova Wheel of Birmingham, Mich. manufactures an all-plastic bearing that is being used for shopping cart caster wheels. This device features an outer race which is molded into the wheel hub. The inner race comprises two bearing “halves” that are snapped to provide the inner race bearing assembly. Two toroidal-shaped plastic rings are used as bearings and are disposed between the inner and outer races. All of the bearing parts including the plastic rings are molded. This structure is also prone to natural mechanical wear and tear resulting in the “wobble wheel” effect due to the fact that “flash” on the bearing rings if left in place serves as source of wear. Removal of the flash and smoothing the ring surface requires extra manufacturing costs. Likewise, the ejection pins that remove the molded rings from their respective molds cause indentations to be made in the surface of the bearing rings, thus, also contributing to wear and tear.

U.S. Pat. No. 5,871,286, issued to Kern et al. on Feb. 16, 1999, dislcoses a molded bearing assembly which includes a synthetic resin outer bearing element embedded in the hub of the molded wheel and has a cylindrical inner sliding, jouranl type bearing surface so that the entire load of this bearing is distributed along the entire length of the assembly, similar to a bronze bushing. This provides greater drag for a given load carrying ability.

Therefore, there is a need for a wheel and bearing assembly and method of making the same, wherein the wheel can use an easily assembled bearing assembly having high tolerances such that can press fit into a molded wheel such that bearing insertion and design itself does not substantially adversely effect the overall performance of the finished wheel and, wherein the wheel can be incorporated into a caster support or other support well known in the art and, wherein the wheel can be produced faster and less expensively than wheels made using present manufacturing techniques and wherein the load of the bearing is located on the outer edges where the diameter is the largest, thus providing for less frictional drag and good load carrying ability.

### SUMMARY OF THE INVENTION

Therefore, it is an aspect of the present invention to provide a bearing assembly that can be produced less expensively than using present construction methods.

It is another aspect of the invention to provide a bearing assembly that is suitable to be incorporated into a molded wheel having high tolerances.

Another aspect of the invention is to provide a molded wheel that uses bearings that are integrally a part of the respective inner and outer race surfaces.

Another aspect of the invention is to provide a bearing having larger diameter outer edges which carries the load so that less frictional drag is experienced for any given load carrying ability.

Still another aspect of the invention is to provide a method of making a molded wheel using easily fabricated components wherein the bearings can be pre-assembled and then easily press fit into the rest of the wheel.

It is a further aspect of this invention to provide a simple method of molding a bearing assembly having only four easily assembled parts.

Another aspect of the invention is to provide a method of making a bearing assembly that eliminates much of the assembly costs.

It is still another aspect of the invention to provide a method of making a molded wheel such that the hub of the wheel can be inexpensively molded yet the molded wheel will have high precision to ensure smooth operating of the wheel bearing assemblies.

Another aspect of the invention is to provide a method of making a molded wheel such that molding the hub can be accomplished with having substantially less scrap using prior art techniques.

It is still another aspect of the invention to provide a method of making a molded wheel where the need for much of the assembly equipment such as the machinery for making the bearing, assembly of the bearings into the hub, etc. can be eliminated.

Finally, it is an aspect of the invention to provide a method of making a molded wheel that can be accomplished using all plastic parts having high precision, ease of assembly, yet providing a smooth running wheel substantially removing “wheel wobble” problems.

The present invention provides a bearing assembly that can be press fit into the hub of the wheel. The bearing assembly includes a molded inner race, preferably in two pieces which snap together, however, a unitary inner race is an alternative embodiment. The outer race also comprises two cap pieces with each cap piece independent from one another and designed to slip over its corresponding inner race bearing section. The bearing surface is provided by designing the inner race and outer race contact surfaces so that they slide freely with respect to one another, thus, eliminating the need for any bearing parts and the attendant problems that additional plastic parts would produce. Each bearing is positioned on each end of the inner race. The outer edges of bearings having a larger diameter than the inner edges. The load is positioned on the outer edges thus provides for less frictional drag. The wheel hub and tread are molded together and the bearing assembly is press fit into the completed wheel. The bearing assembly is completed by press fitting the outer race caps into the hub of the molded wheel and then inserting a male inner race piece through one outer race cap and then its mating female inner race piece through the other outer race cap and then and then snapping the inner race parts together. No special attachment mechanism is required to hold the inner race parts together as long as the parts will remain attached to one another until the wheel is completed and the axle and caster mechanism holds the inner race parts firmly together. The wheel is completed by snapping a guard onto each end of the inner race.

In the preferred embodiment, a split spanner bushing is placed within the spindle opening. The use of the split spanner bushing permits an easier assembly of the two halves of the bearing, helps prevent one bearing turning away from the other, that is, holds the two halves of the bearing together, and provides a stronger surface for the spindle to be inserted into.

These aspects of the invention are not meant to be exclusive. Other features, aspects, and advantages of the present invention will be readily apparent to those of ordinary skill in the art when read in conjunction with the following description, appended claims, and accompanying drawings.

### BRIEF DESCRIPTION OF THE DRAWINGS

FIG. 1 is a side view of the female half of the inner bearing assembly.

FIG. 2 is a side view of an alternative embodiment of the female half of the inner bearing assembly.

FIG. 3 is a side view of the male half of the inner bearing assembly.

FIG. 4 is a side view of an alternative embodiment of the male half of the inner bearing assembly.

FIG. 5 is a top view of the female half of the inner bearing assembly as shown in FIG. 1.

FIG. 6 is a bottom view of the inner bearing assembly as shown in FIGS. 1 and 3.

FIG. 7 is a cross-sectional view of the invention as assembled within the hub of a wheel.

FIG. 8 is an isometric view of the outer race bearing cap.

FIG. 9 is a side cross-sectional view of the outer race bearing cap.

FIG. 10 is an isometric view of the invention installed within a caster wheel.

FIG. 11 is a left/right end view of the split spanner bushing which is included in the preferred embodiment.

FIG. 12 is a longitudinal view of the split spanner bushing shown in FIG. 11.

FIG. 13 is a cross-sectional view of the preferred embodiment of the invention molded into the hub of a wheel.

### DETAILED DESCRIPTION OF THE INVENTION

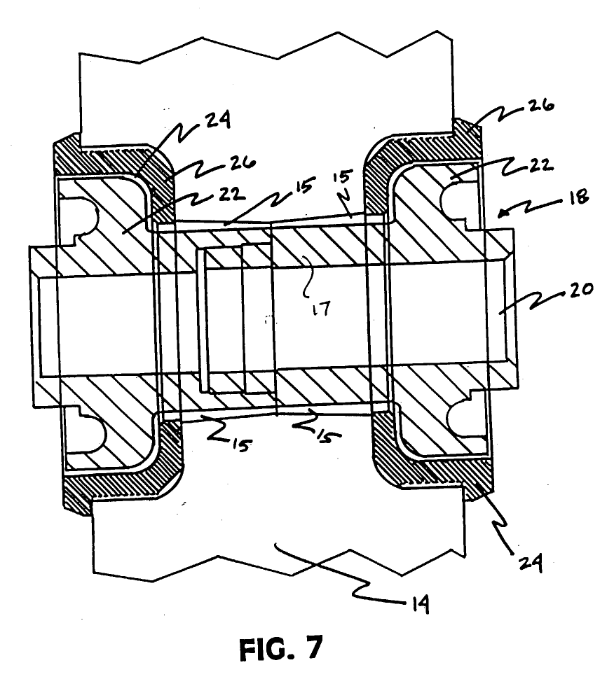

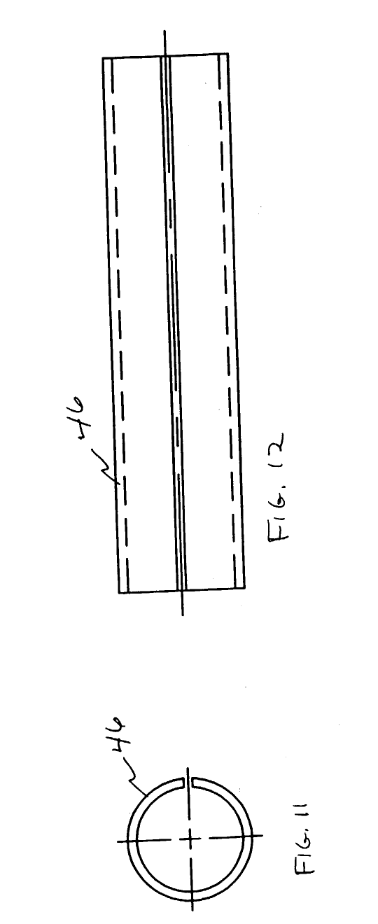

Referring to FIG. 10, the completed caster wheel 10 of the preferred embodiment of the invention is shown. Wheel 10 includes tread 12, hub 14, bearing assembly 18 (shown in FIG. 7) which is covered by guard 16. Bearing assembly 18 provides a spindle opening 20 (see FIG. 7) which is hollow and extends from one side of wheel 10 to the opposing side so that an axle 13 can be inserted therethrough to hold wheel 10 to caster mechanism 11. As shown in the preferred embodiment in FIG. 13, split spanner bushing 46 is inserted into spindle 20, thus holding the two halves of bearing assembly 18 together.

FIG. 7 is a cross-sectional view of the caster wheel 10 of FIG. 1 showing the bearing assembly 18 within. Bearing assembly 18 comprises the inner race 22, the outer race caps 26, and the bearing surfaces 24. Hub 14 and tread (shown in FIG. 10) is molded and then bearing assembly 18 is press fit into hub 14 such clearance 15 is provided between inner race 22 and hub 14. In this manner, when wheel 110 rotates, inner race 22 contacts the hub 14 of wheel 10 only at bearing surfaces 24 as provided by inner race 22 and outer race caps 26. Thus, by having the outer edges of inner race 22 and race caps 26 having a larger diameter than at 17, clearance 15 prevents the load from being distributed along the entire length of bearing assembly, thus reducing frictional drag, yet maintaining good load carrying ability.

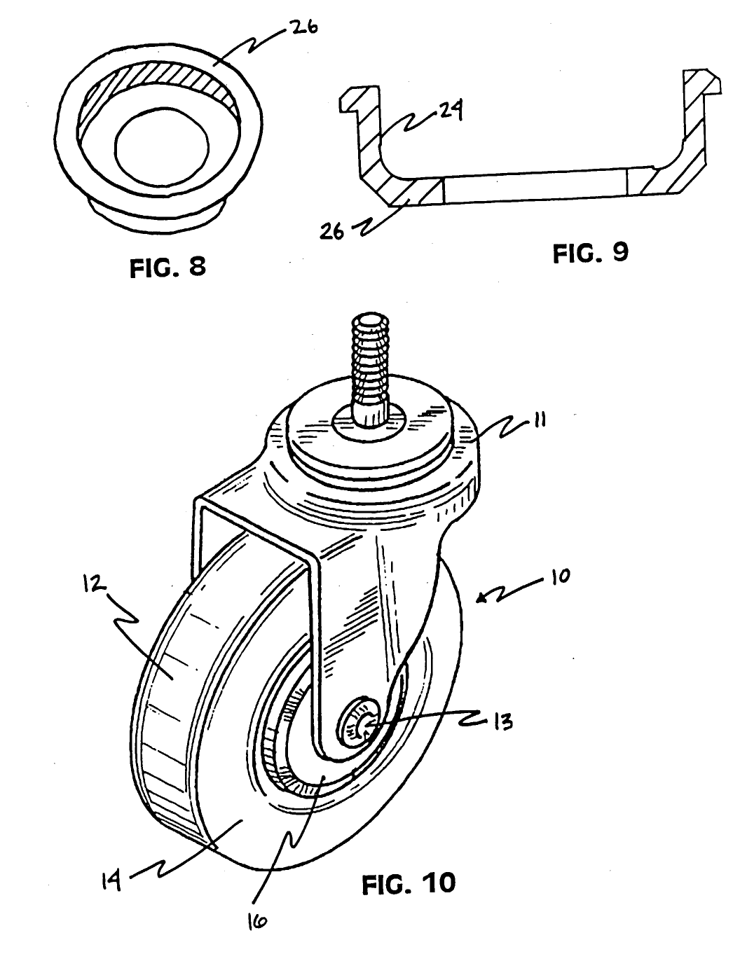

As shown in FIGS. 7, 8, and 9, the outer race is preferably provided by two “caps” 26 that are not connected to one another. Referring to the detail view shown in FIGS. 8 and 9, outer race 26 comprises two substantially identical cap-like structures that serve to encapsulate inner race 22 and provide bearing surfaces 24, that is, a small freely slipping surface on each corresponding inner and outer race part so that minimal friction is encountered, thus ensuring a smooth, easily turning wheel.

Outer race 26 has an internal diameter slightly greater than the bearing surface diameter of inner race 22. However, when configured in this manner, bearing assembly 18 cannot have hub 14 molded to it since the plastic would be able to reach inner race 22 and destroy the function of bearing assembly 18. Using this embodiment, bearing assembly must be press fit into hub 14.

However, as shown in FIG. 7, an alternative embodiment to outer race 26 can be utilized. In this embodiment, outer race 26 could be provided as a single unitary barbell-shaped structure (not shown) or a cap-like structure having two inner collars' that abut one another. In this manner, bearing assembly 18 can be pre-assembled and then hub 14 and tread 12 can be molded to bearing assembly 18 so that the caster wheel can be completed in a two-step process.

Preferably, inner race 22 comprises two pieces (shown in detail in FIGS. 1 and 3) that interlock with one another when pressed together as male spanner bushing 33 and female spanner bushing 31. Groove 25 on female spanner bushing 31 is designed to mate with protrusion 27 on male spanner bushing 33 such that the two halves are held together until such time that caster mechanism 11 ensures that they will be permanently held in place.

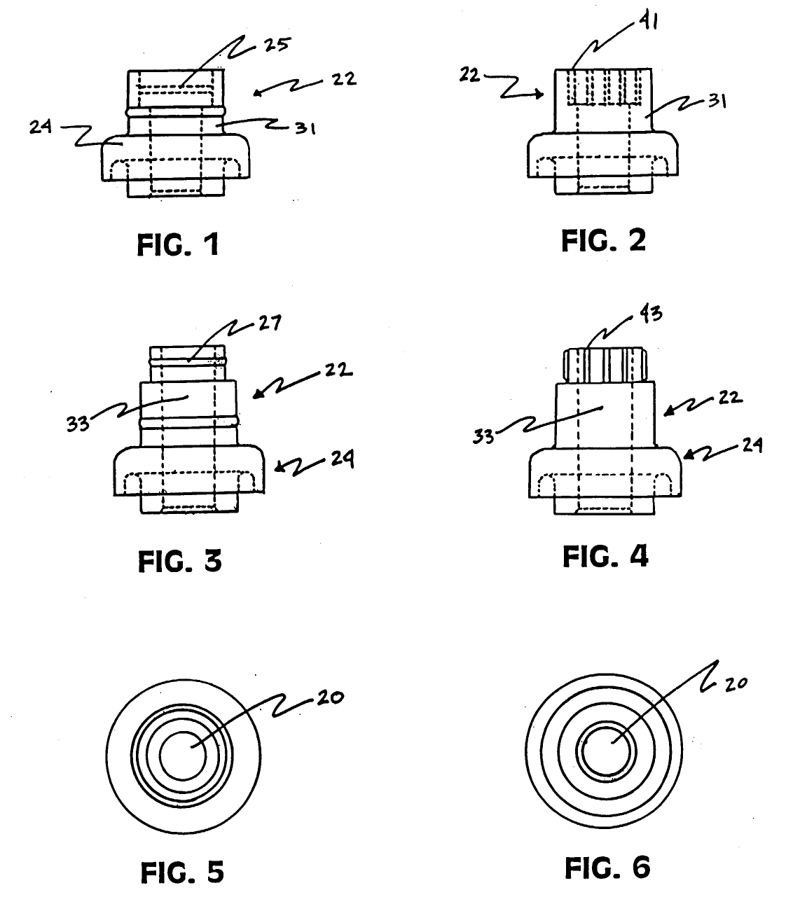

As shown in FIGS. 2 and 4, an alternative method of locking the respective spanner bushing halves together. In this embodiment, axially ribs 43 are mated with axial grooves 41. Other methods can also be used equally as well.

Depending on the method used to construct the wheel, inner race 22 could also be constructed from a single unit. While plastic is the preferable material, metal could also be used. If plastic is used, the preferable material is MINLON or DELRIN, a nylon reinforced plastics sold by E. I. duPont. Inner race 22 provides a bearing surface 24 that is designed to correspond to bearing surface 24 on outer race 26.

While MINLON and DELRIN are the preferred materials for bearing assembly 18 as noted above, any plastic such as polypropylene, polycarbonate, urethane, etc. could be utilized as long as the plastic can be molded accurately to required tolerances and has sufficient strength to meet the bearing requirements of the specified application. Also, metal or a combination of metal and plastic could be used to fabricate either part of or the entire bearing assembly 18 parts.

If the outer race is provided as a single part, then hub 14 and tread 12 can then be molded around bearing assembly 18 using injection molding techniques that are well known in the art. The wheel 10 is completed by snapping on guard 16 which prevents dirt or other foreign material from entering the capsules formed by outer races 26 and inner races 22 causing bearing surfaces 24 to bind and interfering with the smooth rotation of the bearing surfaces 24.

Bearing assemblies 18 are substantially identical to one another on each side of a typical caster wheel, however, this is not essential. Some applications might require a longer spindle 21 on one side compared to the other.

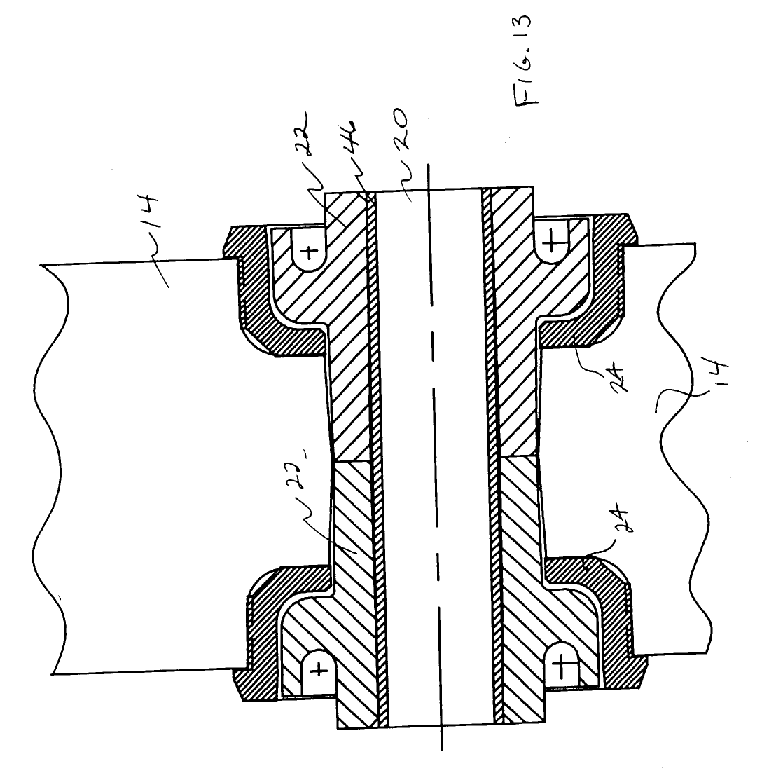

FIGS. 11-13 show the use of split spanner bushing 46 which is used within central opening 20 of inner race members to make easier to assemble inner race members 22 together as well as provided greater strength for an axle (not shown to be supported therein). Further, split spanner bushing 46 will also help hold inner race members 22 together and keep them from turning relative to one another.

The illustrated embodiments of the invention are intended to be illustrative only, recognizing that persons having ordinary skill in the art may construct different forms of the invention that fully fall within the scope of the subject matter appearing in the following claims.

What is claimed is:

1. A bearing assembly for a wheel having an axle comprising:
two opposing inner race members, with each member having an outer edge and inner edge with the outer edge having a substantial larger diameter than the inner edge, and each of said inner race members having a corresponding inner race bearing surface and a central opening;
two opposing outer race members, with each member having an outer edge and inner edge with the outer edge having a substantial larger diameter than the inner edge, and each of said outer race members having corresponding outer race bearing surfaces; such that when each inner race member is mated with its respective outer race member, and said central openings are aligned, a pair of bearing enclosures are provided;
such that each outer race member encapsulates its correspond inner race members such that the bearing surfaces of each are aligned, said inner race members are able to rotate freely with respective to said outer race members, and said wheel is able to freely rotate on an axle positioned within the openings of said inner race members.

2. The bearing assembly of claim 1 wherein said inner race members are integral with one another.

3. The bearing assembly of claim 1 wherein one of said inner race members is provided on a male spanner bushing and the other said inner race member is provided on a female spanner bushing such that said spanner bushings are dimensioned to snap fit together.

4. The bearing assembly of claim 1 wherein said inner race members are molded plastic.

5. The bearing assembly of claim 1 wherein said outer race members are molded plastic.

6. The bearing assembly of claim 1 wherein said outer race members are integral with one another.

7. The bearing assembly of claim 1 wherein each outer race members further comprises a collar such that when said outer race members are in position in said bearing assembly, said collars abut one another.

8. The bearing assembly of claim 1 further comprising a split spanner bushing dimensioned to fit within said aligned central openings of said opposing inner race members.

9. 1. A bearing assembly for a wheel having an axle comprising:
two opposing inner race members, with each member having an outer edge and inner edge with the outer edge having a substantial larger diameter than the inner edge, and each of said inner race members having a corresponding inner race bearing surface and a central opening;
two opposing outer race members, with each member having an outer edge and inner edge with the outer edge having a substantial larger diameter than the inner edge, and each of said outer race members having corresponding outer race bearing surfaces;
a split spanner bushing dimensioned to fit within said central openings of said opposing inner race members.
such that when each inner race member is mated with its respective outer race member, having said central openings aligned and positioned onto said split spanner bushing, a pair of bearing enclosures are provided;
such that each outer race member encapsulates its correspond inner race members such that the bearing surfaces of each are aligned, said inner race members are able to rotate freely with respective to said outer race members, and said wheel is able to freely rotate on an axle positioned within said split spanner bushing of said inner race members.

10. The bearing assembly of claim 9 wherein said inner race members are integral with one another.

11. The bearing assembly of claim 9 wherein one of said inner race members is provided on a male spanner bushing and the other said inner race member is provided on a female spanner bushing such that said spanner bushings are dimensioned to snap fit together.

12. The bearing assembly of claim 9 wherein said inner race members are molded plastic.

13. The bearing assembly of claim 9 wherein said outer race members are molded plastic.

14. The bearing assembly of claim 9 wherein said outer race members are integral with one another.

15. The bearing assembly of claim 9 wherein each outer race members further comprises a collar such that when said outer race members are in position in said bearing assembly, said collars abut one another.
